(19) United States
(12) Patent Application Publication
(10) Pub. No.: US 2022/0309857 A1
(43) Pub. Date: Sep. 29, 2022

(54) MONEY PROCESSING DEVICE

(71) Applicant: Toshiba Tec Kabushiki Kaisha, Tokyo (JP)

(72) Inventor: Yuki Taniike, Sunto Shizuoka (JP)

(21) Appl. No.: 17/546,675

(22) Filed: Dec. 9, 2021

(30) Foreign Application Priority Data
Mar. 25, 2021 (JP) 2021-051154

(51) Int. Cl. G07D 11/235; G07D 11/10; G07D 11/40

(52) U.S. Cl. CPC G07D 11/235; G07D 11/10; G07D 11/40

(57) ABSTRACT

According to one embodiment, a money processing device includes an input port for receiving money from a user and a discharge port for receiving money being returned or dispensed to the user. A controller is configured to selectively open and close storage covers based on a detected denomination of money to selectively store and reject deposited money. The controller also controls the dispensing of money from the storage units to the discharge port as change to the user. A return path connecting to the discharge port is provided to receive rejected money. A discharge sensor detects errors in the dispensing of money to the discharge port. A first informing unit indicates whether money is being discharged to the discharge port as rejected money or whether the discharge sensor has detected an error in the dispensing of money.

### CROSS-REFERENCE TO RELATED APPLICATION

This application is based upon and claims the benefit of priority from Japanese Patent Application No. 2021-051154, filed Mar. 25, 2021, the entire contents of which are incorporated herein by reference.

### FIELD

Embodiments described herein relate generally to a money processing device.

### BACKGROUND

A money processing or handling device that automates the acceptance of customer money deposits (e.g., payments) and the dispensing of money (e.g., change return) has been used in retail stores, such as a supermarket.

However, if a denomination of the money input cannot be correctly determined, the money processing device does not accept the payment and returns the input money to the customer. In some instances, a money processing device sometimes cannot normally execute the discharge of money for such a return because of clogging or the like in the device. Therefore, when the money is to be returned, an operator (e.g., the customer) needs to check whether there is an abnormality in the returned money. On the other hand, in the case of a dispensing error by which the money processing device fails in its normal discharge of money, an operator (e.g., the customer) needs to check whether the discharged money is sufficient.

However, sometimes the operator might not be able to distinguish whether discharge of the money relates to a depositing error or a return of change after settlement or the like.

### BRIEF DESCRIPTION OF THE DRAWINGS

FIG. 1 depicts a self-service POS terminal according to an embodiment.

FIG. 2 is a schematic diagram of a coin processing device.

FIG. 3 is a block diagram illustrating aspects of a coin processing device.

FIG. 4 is a block diagram illustrating aspects of a coin processing device.

FIG. 5 is a flowchart illustrating aspects of processing executed by a coin processing device.

### DETAILED DESCRIPTION

A money processing device according to at least one embodiment provides a technological solution for permitting the distinguishing of whether a discharge of money from a coin processing device is related to a detection of a depositing error or a discharge of change due to the customer for a sales transaction.

In general, according to one embodiment, a money processing device includes an input port for receiving money from a user and a discharge port for receiving money being returned or dispensed to the user. A plurality of storage units is provided for storing money of various denominations. A conveying path is provided from the input port to plurality of storage units. A plurality of covers is provided covering the plurality of storage units. A denomination sensor is provided along the conveyance path and configured to detect a denomination of money on the conveyance path. A controller is configured to: selectively open and close the plurality of covers based on the detected denomination of money by the denomination sensor to permit money on the conveying path to enter a storage unit when the money corresponds to an intended denomination and reject the money when the money does not correspond to an intended denomination; and selectively dispense money from the plurality of storage units to the discharge port to provide change to the user. A return path is provided connecting the conveying path to the discharge port. The return path is configured to receive rejected money from the conveying path. A discharge sensor is configured to detect an error in the dispensing of money from the plurality of storage units to the discharge port. A first informing unit is configured to distinguishably indicate whether money is being discharged to the discharge port as rejected money or whether the discharge sensor has detected an error in the dispensing of money.

A money processing device according to one example embodiment is explained with reference to the accompanying drawings. The example embodiment relates to a money processing device for a retail store or the like, but the present disclosure is not limited thereto and such a money processing device may be adopted in other applications.

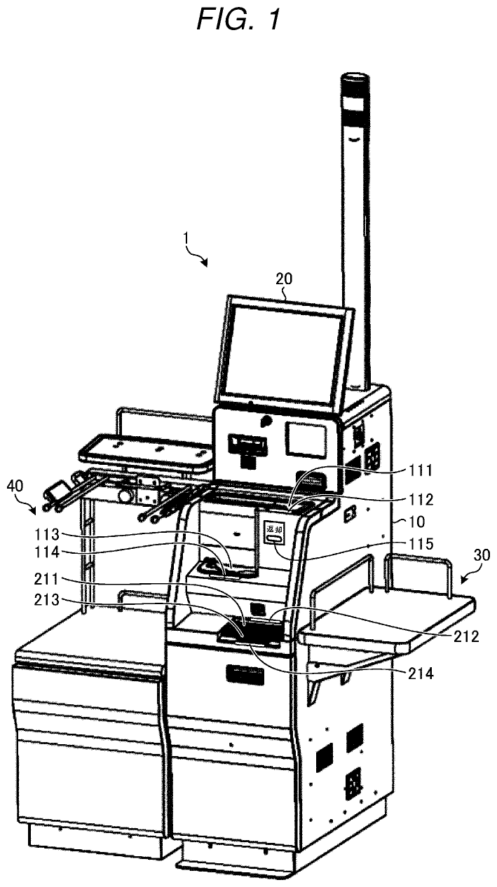

FIG. 1 is a perspective view illustrating an example of an exterior of a self-service point-of-sale (POS) terminal 1 according to an example embodiment. The self-service POS terminal 1 is a device that executes, according to operation of a customer, commodity registration processing for a purchase of a target commodity along with checkout processing for accepting payment of the price of the commodity registered in the commodity registration processing.

The self-service POS terminal 1 includes a main body 10, a display unit 20, a basket table 30, and a bagging table 40. The display unit 20 is a display device that displays various kinds of information according to a state of the commodity registration processing and/or the checkout processing. For example, the display unit 20 is a liquid crystal display. The basket table 30 is disposed on the left side of the main body 10. The basket table 30 is a table on which a shopping basket or the like including unregistered commodities can be placed. The bagging table 40 is disposed on the right side of the main body 10. The bagging table 40 includes a hook or hooks for holding a bag in which the now-registered commodities can be put.

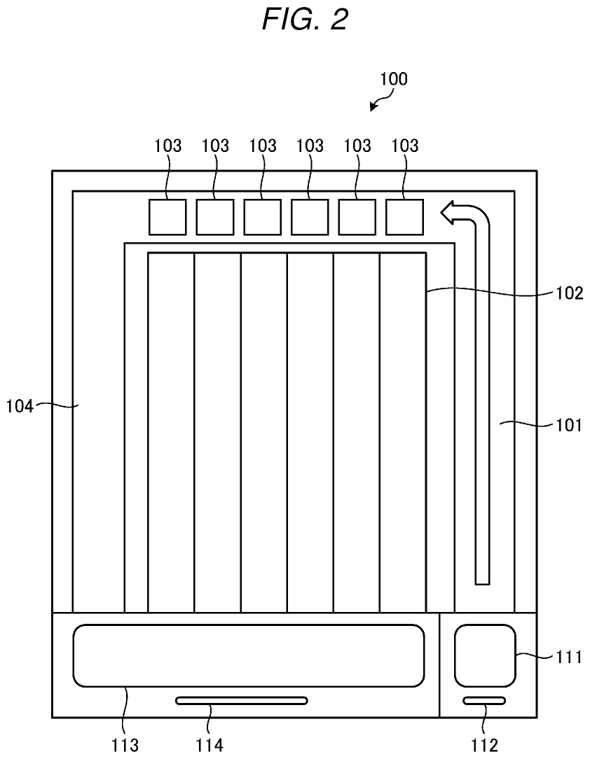

The main body 10 is disposed in the center of the self-service POS terminal 1. The main body 10 may also be referred to as a housing or the like. The self-service POS terminal 1 permits execution of commodity registration based on reading of barcodes encoding a commodity code for identifying a commodity by type, class, or otherwise. The main body 10 houses a coin processing device 100 (see FIG. 2) and a bill processing device.

The coin processing device 100 permits the execution of depositing and dispensing of coins. For example, the coin processing device 100 is one example of a money processing device according to the present disclosure. The bill processing device permits the execution of depositing and dispensing of bills.

The main body 10 includes a coin input port 111 and a coin discharge port 113 on the front surface. The coin input port 111 is for receiving coins from the customer/operator of self-service POS terminal 1.

The main body 10 includes an input port informing unit 112 in the vicinity of the coin input port 111. The input port informing unit 112 informs the customer that input coins have been received. The input port informing unit 112 is a light emitting body, lamp, or the like. For example, the input informing unit 112, is an LED (Light Emitting Diode) or a plurality of such that can be lit in two distinguishable colors such as blue and red. For example, the input port informing unit 112 is lit in blue when coins are being received.

The input port informing unit 112 indicates a reason for why coins are being returned (discharged) via the coin discharge port 113. For example, the input port informing unit 112 indicates that an abnormal input of coins was performed. Return of money for such a reason is also referred to as a reject, a rejection, a depositing error return, an invalid deposit return or the like. The coin processing device 100 immediately returns the deposited coins, for example, if denominations of the deposited coins cannot be distinguished or identified. The coin processing device 100 also returns coins if the coins or identified denominations of the coins are those of a foreign country, tokens used in a game (e.g., arcade tokens), or the like. By indicating the return reason in this way, the input port informing unit 112 urges the operator to check whether the wrong coins were input. In this context, returned money/coins is not limited to actual coins but may be other objects or debris.

The input port informing unit 112 may indicate a state not only with red and blue lights but also with additional colors. Further, the input port informing unit 112 may indicate a state with methods other than the usage of different colors such as with flashing, blinking, different light positions, number of lit lights, changes in intensity, shapes, or the like.

The coin discharge port 113 is used for discharging coins as change due in a sales transaction or the like. The coin discharge port 113 includes a saucer for receiving discharged coins. The coin discharge port 113 also receives discharges of coins (or other items) for return/rejection purposes and when a depositing error is detected. The coin processing device 100 discharges coins to the coin discharge port 113 for different reasons such as discharge of change due and return of depositing errors.

The main body 10 includes a discharge port informing unit 114 in the vicinity of the coin discharge port 113. The discharge informing unit 114 indicates if coins are being discharged to the coin discharge port 113. The discharge port informing unit 114 indicates a depositing error if the coins are being discharged based on a detection of a depositing error.

In the present example, the discharge port informing unit 114 is a light emitting body, lamp, or the like. For example, discharge port informing unit 114 is an LED that can be lit in two distinguishable colors such as blue and red. For example, the discharge port informing unit 114 is lit in blue when coins are being discharged for a normal reason (e.g., as change due or for an invalid deposit return) rather than as a result of a dispensing error. When coins are being returned for a normal reason (that is, no dispensing error has been detected), the discharging port informing unit 114 indicates a normal state (e.g., blue light). The input port informing unit 112 can be lit in red if a dispensing error is detected (that is, the discharge relates to an abnormal reason). A dispensing error is indicated whenever an abnormality is detected in the discharge of money. For example, a dispensing error is indicated if some or all of the necessary change cannot be discharged because of clogging or the like.

In this example, the discharge port informing unit 114 is also lit in blue if the discharge relates to return of an invalid deposit. That is, so long as a dispensing error is not detected, the discharge port informing unit 114 indicates a valid dispensing with the same manner whether the discharge relates to deposit error or a return of change due. In other words, the discharge port informing unit 114 serves to indicate when coins are not appropriately discharged.

The discharge port informing unit 114 may indicate a state not only with red and blue colors but also with other colors. Further, the discharge port informing unit 114 may indicate a state with methods other than color changes such as flashing, blinking, different light positions, number of lit lights, changes in intensity, shapes, or the like.

The main body 10 includes a return informing unit 115 below the coin input port 111 on the front surface. The return informing unit 115 distinguishably indicates either an intended return of coins or a dispensing error.

More specifically, in this example, the return informing unit 115 indicates that money is being discharged to the coin discharge port 113 for purposes of invalid deposit return. The return informing unit 115 can be a light emitting body such as an LED that is lit in red. If coins are being returned, the return informing unit 115 is lit in red. On the other hand, the return informing unit 115 is not lit when a dispensing error has been detected. Consequently, the return informing unit 115 distinguishably indicates either an intended return of coins or a dispensing error.

The return informing unit 115 may indicate a state not only with red light but also with other colors. Further, the discharge port informing unit 114 may indicate a state with methods other than by colors such as flashing, blinking, different light positions, number of lit lights, changes in intensity, shapes, or the like.

The coin processing device 100 is explained with reference to FIG. 2. FIG. 2 is a schematic diagram illustrating an example of a coin processing device 100 according to an embodiment. FIG. 2 more specifically indicates aspects of an internal structure of the coin processing device 100.

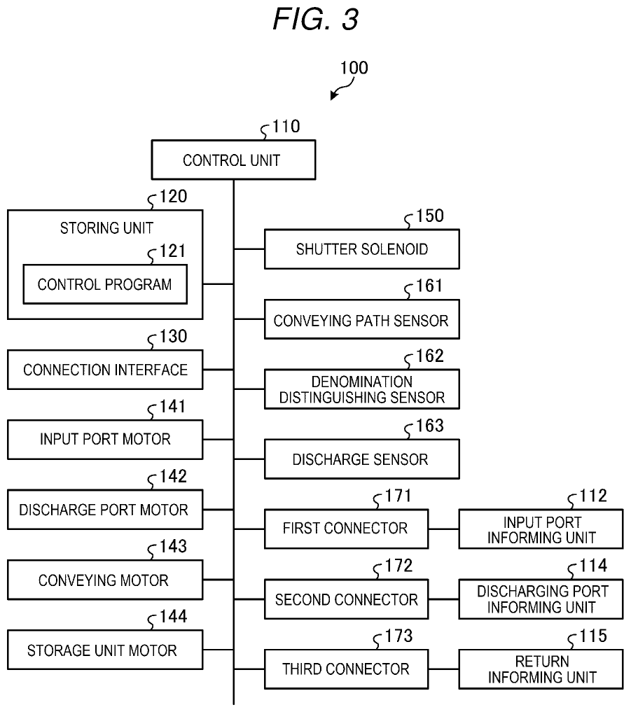

The coin processing device 100 includes a conveying path 101, storage units 102, shutters 103 (by coin denomination), and a return path 104. When coins are input to the coin input port 111, the conveying path 101 conveys these input (deposited) coins. On the conveying path 101, a conveying path sensor 161 (see FIG. 3) and a denomination distinguishing sensor 162 (see FIG. 3) are provided. The conveying path sensor 161 is a sensor that detects coins being conveyed by the conveying path 101. For example, the conveying path sensor 161 is an optical sensor that detects the presence of coins with light. Once the conveying path sensor 161 detects coins are present, the denomination distinguishing sensor 162 then attempts to distinguish the denomination(s) of the detected coins.

The storage units 102 are available to store coins for each of the expected denominations. For example, individual storage units 102 are provided to store coins for 500 yen, 100 yen, 50 yen, 10 yen, 5 yen, and 1 yen denominations. The storage units 102 maybe such things as storage tubes, trays, boxes, or the like. The shutters 103 are shutters provided on the storage units 102 for different denominations. The shutters 103 are opened and closed by operation of a shutter solenoid 150 (see FIG. 3) controlled by the control unit 110.

The denomination distinguishing sensor 162 identifies or detects the denominations of the coins being conveyed on the conveying path 101. If the detected denominations of the coins conveyed on the conveying path 101 correspond to the intended denominations of at least one of the storage units 102, a shutter solenoid 150 opens the appropriate shutters 103 by denomination. On the other hand, if the denominations of the coins conveyed on the conveying path 101 do not correspond to the intended denominations of any of the storage units 102, then no shutter solenoid 150 opens any of the shutters 103. That is, the shutter solenoids 150 maintain a closed state of the shutters 103. By such operations, the coin processing device 100 stores only those coins corresponding to the pre-established denominations for the storage units 102.

The return path 104 conveys coins to be returned (e.g., rejected coins) to the coin discharge port 113. Thus, if the denomination distinguishing sensor 162 cannot distinguish a denomination of a coin (or object) being conveyed on the conveyance path 101 (or otherwise determines that the detected denomination is not an intended denomination for storage), then none of the shutters 103 will be opened and such a coin (or object) will not be admitted to the storage units 102. Any coins (or objects) that are not admitted to one of the storage units 102 is conveyed past the storage units 102 to the return path 104. That is, rejected coins are conveyed to the return path 104. The return path 104 conveys the rejected coins to the coin discharge port 113.

FIG. 3 is a block diagram illustrating an example of the hardware configuration of a coin processing device 100 according to an embodiment.

The coin processing device 100 includes a control unit 110, a storing unit 120, a connection interface 130, an input port motor 141, a discharge port motor 142, a conveying motor 143, a storage unit motor 144, a shutter solenoid 150, a conveying path sensor 161, a denomination distinguishing sensor 162, a discharge sensor 163, a first connector 171, a second connector 172, and a third connector 173. These units are connected to the control unit 110 via a system bus such as a data bus or an address bus.

The control unit 110 is, for example, a computer that controls the overall operations of the coin processing device 100. The control unit 110 comprises, in this example, a CPU (Central Processing Unit), a ROM (Read Only Memory), and a RAM (Random Access Memory). The CPU (processor) controls the operations of the coin processing device 100. The ROM is a storage medium from which various programs and various data can read out. The RAM is a storage medium in which readout and writing of various programs and various data can be executed. The CPU executes programs stored in the ROM, the storing unit 120, or the like using the RAM as a work area (a work region).

The storing unit 120 is a data storage device such as an HDD (Hard Disk Drive), an SSD (Solid State Drive), or a flash memory. The storing unit 120 stores a control program 121. The control program 121 can be an operating system or an application program for performing certain described functions of the coin processing device 100.

In some examples, the coin processing device 100 need not include a storing unit 120. In such a case, the control program 121 can stored in ROM or other storage types integrated within the control unit 110. The RAM of the control unit 110 stores various settings and information.

The connection interface 130 is for connection to the self-service POS terminal 1. The total amount paid by a customer in the checkout processing of a sales transaction can be acquired from the self-service POS terminal 1 via the connection interface 130.

The input port motor 141 drives a belt to convey coins inserted into the coin input port 111 to the conveying path 101.

The discharge port motor 142 drives a belt for conveyance of coins from the storage units 102 to the coin discharge port 113.

The conveying motor 143 drives a belt to convey coins along the conveying path 101.

The storage unit motor 144 drives a belt in the storage units 102 to convey coins from the storage units 102.

A shutter solenoid 150 opens and closes each of the shutters 103. In some examples, a plurality of shutter solenoids 150 may be provided.

The conveying path sensor 161 detects the presence of coins on the conveying path 101. For example, the conveying path sensor 161 is an optical sensor that detects coins based on reflected light.

The denomination distinguishing sensor 162 serves to identify particular denominations of the coins being conveyed on the conveying path 101.

The discharge sensor 163 detects when coins are being discharged to the coin discharge port 113. For example, a discharge sensor 163 is provided for each of the storage units 102. A detection result from the discharge sensor 163 can also be used for counting the number of discharged coins for each of the denominations being discharged.

The first connector 171 is interface connection or connector for connection to the input port informing unit 112. The input port informing unit 112 is connected to the coin processing device 100 via the first connector 171. The coin processing device 100 controls the input port informing unit 112. In some examples, the coin processing device 100 may integrate the input port informing unit 112 therein.

The second connector 172 is interface connection or connector for connection to the discharge port informing unit 114. The discharge port informing unit 114 is connected to the coin processing device 100 via the second connector 172. The coin processing device 100 controls the discharge port informing unit 114. In some examples, the coin processing device 100 may integrate the discharge port informing unit 114 therein.

The third connector 173 is interface connection or connector for connection to the return informing unit 115. The return informing unit 115 is connected to the coin processing device 100 via the third connector 173. The coin processing device 100 controls the return informing unit 115. In some examples, the coin processing device 100 may integrate the return informing unit 115 therein.

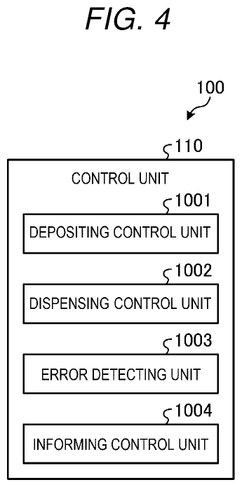

FIG. 4 is a block diagram related to functional aspects of a coin processing device 100 according to the present embodiment.

The control unit 110 of the coin processing device 100 loads a control program 121 from the storing unit 120 on to RAM inside (or otherwise attached) to the control unit 110 and then executes the control program 121. The control unit 110 (controller) may include therein a central processor unit (CPU) or other type processor. The control unit 110 executing control program 121 may be considered to provide the various depicted functional units depicted in FIG. 4. More specifically, in this example, the control unit 110 of the coin processing device 100 provides the described functions of a depositing control unit 1001, a dispensing control unit 1002, an error detecting unit 1003, and an informing control unit 1004.

The depositing control unit 1001 controls depositing of coins input to the coin input port 111. The input port motor 141 conveys the coins input to the coin input port 111 to the conveying path 101. After a coin (or coins) is detected by the conveying path sensor 161, the denomination distinguishing sensor 162 then distinguishes (identifies) the coin(s). The depositing control unit 1001 identifies, based on results from the denomination distinguishing sensor 162, how many coins of each denomination have been input. That is, the depositing control unit 1001 calculates a total deposit amount (monetary value) for the input coins.

If some possible denominations of coins are not identified as present in the input coins by the denomination distinguishing sensor 162, the shutter solenoid 150 does not open the shutters 103 for such denominated coins. Likewise, if no expected denominations are identified in the input coins, then no shutters 103 are opened and none of the deposited coins are added to the storage units 102. Subsequently, the conveying motor 143 conveys the unidentified coins to the return path 104. The discharge port motor 142 discharges the unidentified coins (or objects) to the coin discharge port 113. That is, the coin processing device 100 returns unidentified coins and coins not matching an intended denomination. Thus, if a coin denomination is not identified by the denomination distinguishing sensor 162, the depositing control unit 1001 operates to immediately return the coin.

The dispensing control unit 1002 controls discharging of coins to the coin discharge port 113. More specifically, the dispensing control unit 1002 acquires the amount of change due to the customer and dispenses coins from the storage units 102 to provide the change due. For example, the dispensing control unit 1002 subtracts the amount due in the sales transaction from the total amount deposited by the customer to calculate the amount of change required for the sales transaction. In some examples, the dispensing control unit 1002 acquires the required amount of change from the self-service POS terminal 1 connected via the connection interface 130. The dispensing control unit 1002 calculates the number and denominations of coins to be dispensed based on the required amount of change.

The error detecting unit 1003 detects an error in the dispensing of coins. More specifically, the error detecting unit 1003 counts, based on a detection result from the discharge sensor 163, the number of coins discharged to the coin discharge port 113 by denominations. The error detecting unit 1003 compares the intended number of coins for each of the denominations to be discharged (as calculated by the dispensing control unit 1002) to the number of the coins of each of the denominations actually discharged to the coin discharge port 113. The error detecting unit 1003 detects a dispensing error (abnormal operation) if the comparison indicates that the intended number of coins to be dispensed and the number of coins actually discharged do not coincide. That is, if the number of coins discharged is less than the intended number of coins or if the number of coins discharged is greater than the intended number of coins, the error detecting unit 1003 detects an occurrence of a dispensing error. On the other hand, if the comparison indicates that the intended number of coins and the discharged number of coins coincide, the error detecting unit 1003 determines that a dispensing error did not occur (normal operation). In some examples, the error detecting unit 1003 may detect not only a mismatch in the number of coins to be dispensed and the number of coins discharged but also other events as a dispensing error.

The informing control unit 1004 controls the input port informing unit 112, the discharge port informing unit 114, and the return informing unit 115 to indicate depositing and dispensing states. The depositing state is a state in which coins are received. If a return (e.g., a rejection) of coins is detected while in the depositing state, the informing control unit 1004 determines that the coin processing device 100 is now in a return state. The dispensing state is a state in which coins are discharged. If a dispensing error is detected while in the dispensing state, the informing control unit 1004 determines that the coin processing device 100 is now in a dispensing error state.

In the depositing state, the informing control unit 1004 causes the input port informing unit 112 to indicate that the input of the coins is being received. For example, the informing control unit 1004 lights the lamp/light of the input port informing unit 112 in blue, extinguishes the lamp/light of the discharge port informing unit 114, and extinguishes the lamp/light of the return informing unit 115.

In the return state, the informing control unit 1004 causes the input port informing unit 112 to indicate that an abnormal (invalid) input of the coins has been received. The informing control unit 1004 causes the discharge port informing unit 114 to indicate that the coins are being or have been discharged. The informing control unit 1004 causes the return informing unit 115 to indicate that the coins are being or have been rejected. For example, the informing control unit 1004 lights the lamp/light of the input port informing unit 112 in red, lights the lamp/light of the discharge port informing unit 114 in blue, and lights the lamp/light of the return informing unit 115 in red.

In the dispensing state, the informing control unit 1004 causes the discharge port informing unit 114 to indicate that the coins are being or have been discharged as change. For example, the informing control unit 1004 extinguishes the lamp/light of the input port informing unit 112, lights the lamp/light of the discharge port informing unit 114 in blue, and extinguishes the lamp/light of the return informing unit 115.

In the dispensing error state, the informing control unit 1004 causes the discharge port informing unit 114 to indicate that a dispensing error was detected. For example, the informing control unit 1004 extinguishes the lamp/light of the input port informing unit 112, lights the lamp/light of the discharge port informing unit 114 in red, and extinguishes lamp/light of the return informing unit 115.

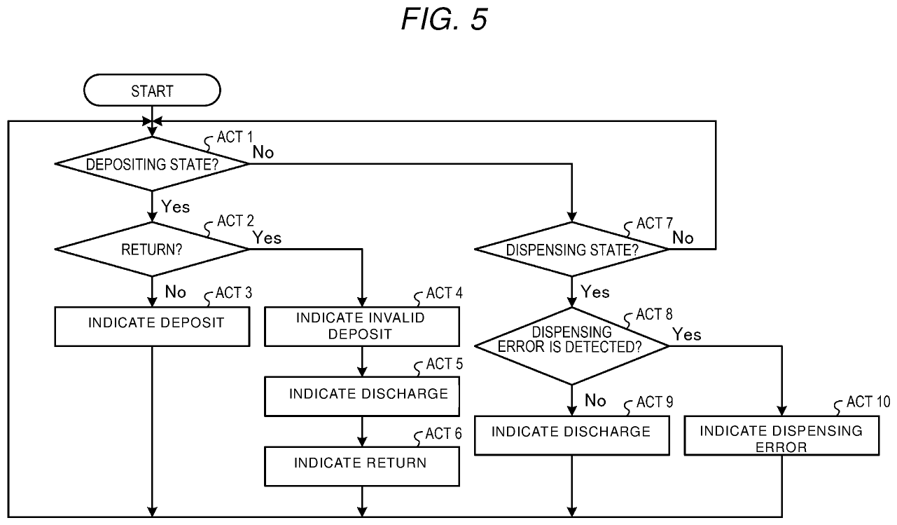

FIG. 5 is a flowchart illustrating an example of the processing executed by the coin processing device 100 according to this example embodiment.

The informing control unit 1004 determines whether the coin processing device 100 is in a depositing state (Act 1).

If the coin processing device 100 is in the depositing state (Act 1; Yes), the depositing control unit 1001 next determines whether there are coins to be returned (rejected) (Act 2).

If there are no coins to be returned (Act 2; No), the informing control unit 1004 causes the input port informing unit 112 to indicate that input (deposit) of coins has been received (Act 3). That is, the informing control unit 1004 lights the lamp/light of the input port informing unit 112 in blue. For example, in a period of time before any input of the coins is received or if an input of the coins has been normally performed, the depositing control unit 1001 determines that there are no coins to be returned at present. That is, the informing control unit 1004 lights the lamp/light of the input port informing unit 112 in blue before the input of the coins is received and if the input of the coins is normal.

If there are deposited coins to be returned (due to an abnormal deposit or the like) (Act 2; Yes), the informing control unit 1004 causes the input port informing unit 112 to indicate that an abnormal deposit of coin(s) has been received (Act 4). That is, the informing control unit 1004 lights the lamp/light of the input port informing unit 112 in red.

The informing control unit 1004 causes the discharge port informing unit 114 to indicate that the coins are being or have recently been discharged (Act 5). That is, the informing control unit 1004 lights the lamp/light of the discharge port informing unit 114 in blue.

The informing control unit 1004 causes the return informing unit 115 to indicate that the coins are being or have been recently returned for being rejected (Act 6). That is, the informing control unit 1004 lights the lamp/light of the return informing unit 115 in red.

If the coin processing device 100 is not in the depositing state (Act 1; No), the dispensing control unit 1002 determines whether the coin processing device 100 is in a dispensing state (Act 7). If the coin processing device 100 is not in the dispensing state (Act 7; No), the coin processing device 100 returns to Act 1.

If the coin processing device 100 is in the dispensing state (Act 7; Yes), the error detecting unit 1003 next determines whether a dispensing error is detected (Act 8). If a dispensing error is not detected (Act 9; No), the informing control unit 1004 causes the lamp/light of the discharge port informing unit 114 to indicate that the coins are being or have recently been discharged (Act 9). For example, the informing control unit 1004 lights the lamp/light of the discharge port informing unit 114 in blue.

If a dispensing error is detected (Act 9; Yes), the informing control unit 1004 causes the discharge port informing unit 114 to indicate that a dispensing error has been detected (Act 10). For example, the informing control unit 1004 lights the lamp/light of the discharge port informing unit 114 in red.

The coin processing device 100 of the present example executes a user informing process.

As explained above, the coin processing device 100 according to this example embodiment includes a coin discharge port 113 for the discharging of coins for both the return of erroneously deposited coins and the provision of change due. That is, the coin processing device 100 discharges all coins to the coin discharge port 113 irrespective of the discharge reason. The return informing unit 115 distinguishably indicates whether the coins discharged via the coin discharge port 113 are being properly returned as result of an abnormal deposit or improperly as a result of a dispensing error. Accordingly, even when coins are always discharged to the same discharge port no matter the reason, the operator/customer using the coin processing device 100 can understand whether a discharge is the result of return of an abnormal deposit, a dispensing error, or as change due.

In the above examples, the coin processing device 100 is included in a self-service POS terminal 1 that executes commodity registration and the checkout processing. However, in other examples, the coin processing device 100 may be mounted in a separate checkout device or module in a semi-self-service checkout system with a registration device operated by a store clerk and a separate checkout device for checkout processing to be operated by the customer. Similarly, the coin processing device 100 may also or instead be mounted on an otherwise standard, clerk-operated POS terminal. Likewise, the coin processing device 100 may be mounted on other device types such as standalone payment kiosks, ticket booths, vending machines, or the like.

In the above examples, a coin processing device 100 is explained as one example of a money processing device. However, the money processing device may also or instead be a bill processing device that processes bills or a payment processing device that processes both coins and bills. Such devices may include separate return informing units for coins and for bills or may share a single return informing unit for coins and bills.

The input port informing unit 112, the discharge port informing unit 114, and the return informing unit 115 are each explained above as being a light emitting body such as an LED. However, the input port informing unit 112, the discharge port informing unit 114, and the return informing unit 115 may indicate states/statuses not only with light emission but by or other methods. For example, the input port informing unit 112, discharge port informing unit 114, and the return informing unit 115 may be or incorporate speakers that indicate device states or status by sound in addition to or instead with lights. Further, the input port informing unit 112, discharge port informing unit 114, and the return informing unit 115 may be or incorporate images such as icons displayed on the display unit 20. For example, the operator can distinguish device states according to whether particular images or messages are displayed on the display unit 20.

The programs executed by the various devices in these embodiments can be provided to end users by being incorporated in storage media (ROMs or storing units) included in the devices at the time of transfer to the end user but are methods are possible. The programs may be recorded in a non-transitory computer-readable recording media such as a CD-ROM, a flexible disk (FD), a CD-R, and a DVD (Digital Versatile Disk) in files of an installable format or an executable format. The program(s) can be transmitted by a LAN (Local Area Network), the Internet, or the like and/or downloaded via these means.

The programs executed by the devices in these embodiments may be stored on a computer connected to a network such as the Internet and provided across a network by download or may be distributed across the network.

While certain embodiments have been described, these embodiments have been presented by way of example only, and are not intended to limit the scope of the disclosure. Indeed, the novel apparatus and methods described herein may be embodied in a variety of other forms; furthermore, various omissions, substitutions and changes in the form of the apparatus and methods described herein may be made without departing from the spirit of the disclosure. The accompanying claims and their equivalents are intended to cover such forms or modifications as would fall within the scope and spirit of the disclosure.

What is claimed is:

1. A money processing device, comprising:
an input port for receiving money from a user;
a discharge port for receiving money being returned or dispensed to the user;
a plurality of storage units for storing money of various denominations;
a conveying path from the input port to plurality of storage units;
a plurality of covers covering the plurality of storage units;
a denomination sensor along the conveyance path and configured to detect a denomination of money on the conveyance path;
a controller configured to:
selectively open and close the plurality of covers based on the detected denomination of money by the denomination sensor to permit money on the conveying path to enter a storage unit when the money corresponds to an intended denomination and reject the money when the money does not correspond to an intended denomination, and
selectively dispense money from the plurality of storage units to the discharge port to provide change to the user;
a return path connecting the conveying path to the discharge port and configured to receive rejected money from the conveying path;
a discharge sensor configured to detect an error in the dispensing of money from the plurality of storage units to the discharge port; and
a first informing unit configured to distinguishably indicate whether money is being discharged to the discharge port as rejected money or whether the discharge sensor has detected an error in the dispensing of money.

2. The money processing device according to claim 1, wherein the money is coins.

3. The money processing device according to claim 1, wherein
the first informing unit comprises a lamp, and
the first informing unit indicates rejected money is being discharged by lighting the lamp a first color and indicates the error in the dispensing of money by lighting the lamp a second color different from the first color.

4. The money processing device according to claim 1, wherein the first informing unit is spaced from the input port and the discharge port.

5. The money processing device according to claim 1, further comprising:
a second informing unit configured to indicate when money is deposited via the input port, wherein
the second informing unit indicates deposited money is being rejected based on output of the denomination sensor.

6. The money processing device according to claim 5, wherein the second informing unit is adjacent to the input port.

7. The money processing device according to claim 5, wherein
the second informing unit comprises a lamp, and
the second informing unit indicates deposited money is being rejected by lighting the lamp a first color and indicates depositing of money by lighting the lamp a second color different from the first color.

8. The money processing device according to claim 1, further comprising:
a third informing unit configured to indicate when money has been dispensed to the discharge port as change to the user or if an error in dispensing has been detected by the discharge sensor.

9. The money processing device according to claim 8, wherein the third informing unit is adjacent to the discharge port.

10. The money processing device according to claim 8, wherein the third informing unit also indicates when rejected money is being discharged to the discharge port.

11. The money processing device according to claim 10, wherein the third informing unit indicates both when money is being dispensed as change to the user and when rejected money is being discharged in an identical manner.

12. The money processing device according to claim 9, wherein
the third informing unit comprises a lamp, and
the third informing unit indicates money is being dispensed as change by lighting the lamp a first color and indicates an error in the dispensing of change has been detected by the discharge sensor by lighting the lamp a second color different from the first color.

13. The money processing device according to claim 1, further comprising:
a second informing unit configured to indicate when money is deposited via the input port; and
a third informing unit configured to indicate when money has been dispensed to the discharge port as change to the user or if an error in dispensing has been detected by the discharge sensor, wherein
the second informing unit indicates deposited money is being rejected based on output of the denomination sensor.

14. A point-of-sale terminal, comprising:
a housing;
an input port on the housing for receiving money from a user;
a discharge port on the housing for receiving money being returned or dispensed to the user;
a plurality of storage units in the housing for storing money of various denominations;
a conveying path from the input port to plurality of storage units;
a plurality of covers covering the plurality of storage units;
a denomination sensor along the conveyance path and configured to detect a denomination of money on the conveyance path;
a controller configured to:
selectively open and close the plurality of covers based on the detected denomination of money by the denomination sensor to permit money on the conveying path to enter a storage unit when the money corresponds to an intended denomination and reject the money when the money does not correspond to an intended denomination, and
selectively dispense money from the plurality of storage units to the discharge port to provide change to the user;
a return path connecting the conveying path to the discharge port and configured to receive rejected money from the conveying path;
a discharge sensor configured to detect an error in the dispensing of money from the plurality of storage units to the discharge port; and
a first lamp on an exterior of the housing and configured to distinguishably indicate whether money is being discharged to the discharge port as rejected money or whether the discharge sensor has detected an error in the dispensing of money.

15. The point-of-sale terminal according to claim 14, wherein the money is coins.

16. The point-of-sale terminal according to claim 14, further comprising:
a second lamp on the exterior of the housing adjacent to the input port and configured to indicate when money is deposited via the input port, wherein
the second lamp indicates deposited money is being rejected based on output of the denomination sensor.

17. The point-of-sale terminal according to claim 16, further comprising:
a third lamp on the exterior of the housing adjacent to the discharge port and configured to indicate when money has been dispensed to the discharge port as change to the user or if an error in dispensing has been detected by the discharge sensor.

18. The point-of-sale terminal according to claim 14, further comprising:
a third lamp on the exterior of the housing adjacent to the discharge port and configured to indicate when money has been dispensed to the discharge port as change to the user or if an error in dispensing has been detected by the discharge sensor.

19. A coin handling machine, comprising:
an input port for receiving coins from a user;
a discharge port for receiving coins being returned or dispensed to the user;
a plurality of storage units for storing coins of various denominations;
a conveying path from the input port to plurality of storage units;
a plurality of covers covering the plurality of storage units;
a denomination sensor along the conveyance path and configured to detect a denomination of coins on the conveyance path;
a controller configured to:
selectively open and close the plurality of covers based on the detected denomination of the coins by the denomination sensor to permit a coin on the conveying path to enter a storage unit when the coin corresponds to an intended denomination and reject the coin when the coin does not correspond to an intended denomination, and
selectively dispense coins from the plurality of storage units to the discharge port to provide change to the user;
a return path connecting the conveying path to the discharge port and configured to receive rejected coins from the conveying path;
a discharge sensor configured to detect an error in the dispensing of coins from the plurality of storage units to the discharge port;
a first informing unit configured to distinguishably indicate whether coins are being discharged to the discharge port as rejected coins or whether the discharge sensor has detected an error in the dispensing of coins; and
a second informing unit adjacent to the input port and configured to indicate when coins are deposited via the input port, wherein
the second informing unit indicates deposited coins are being rejected based on output of the denomination sensor.

20. The coin handling machine according to claim 19, further comprising:
a third informing unit configured to indicate when coins have been dispensed to the discharge port as change to the user or if an error in dispensing has been detected by the discharge sensor.
